(19) United States
(12) Patent Application Publication
(10) Pub. No.: US 2020/0031015 A1
(43) Pub. Date: Jan. 30, 2020

(54) HOPPER FLASHING

(71) Applicant: Superior Tire and Rubber Corp., Warren, PA (US)

(72) Inventor: Tim Rowles, Youngsville, PA (US)

(21) Appl. No.: 16/523,769

(22) Filed: Jul. 26, 2019

Related U.S. Application Data
(60) Provisional application No. 62/711,323, filed on Jul. 27, 2018.

(51) Int. Cl. B28C 5/08; B65D 88/26

(52) U.S. Cl. CPC B28C 5/0806; B65D 88/26

(57) ABSTRACT

A hopper flashing for a hopper of a paving machine that is removably coupled to a lead edge of the hopper, made of a urethane compound such as MDI caprolactone or polycaprolactone, or TDI ester, and useable on its own or as provided between wing hopper flashings to help retain asphalt in the hopper.

### CROSS-REFERENCE TO RELATED APPLICATIONS

This application is related to and claims priority from U.S. Provisional Patent Application No. 62/711,323, filed Jul. 27, 2018, the entirety of which is hereby incorporated by reference.

### FIELD

The present inventions relate to the field of paving equipment. The present inventions more specifically relate to the field of hopper flashing, guards and skirts for paving machine hoppers.

### BACKGROUND

In a conventional asphalt paving system, a hot mix of asphalt is fed or provided into a hopper of a paver. For example, a dump truck or other vehicle carrying asphalt typically comes in close to a front or lead edge of the hopper and dumps or otherwise provides asphalt into the hopper.

Conventional hoppers utilize flashing, guards or skirts to help keep the asphalt contained within the hopper as desired. Typically, the hopper has a center hopper flashing provided between two hopper wing flashings.

Conventional center hopper flashing, guards and skirts are made of rubber or ultra-high-molecular-weight polyethylene (UHMW). However, flashing guards and skirts made of rubber or UHMW tend to break down from heat, abrasion and other conditions common to the conventional application. Known rubber and UHMW hopper flashing does not stand up well to the hot asphalt and trucks that are delivering the asphalt to the machine, and hopper flashing is a major wear component of a paver.

Asphalt heat is a significant issue for hopper flashing made of UHMW, as the hot mix asphalt typically arrives at a job site at a temperature of around between 275 and 300 deg F. For initial rolling, the temperature of the mix should be between 220 and 290 deg F., and a mix below 185 deg F. before compaction tends to be too stiff to compact properly.

However, the maximum temperature rating for UHMW is 180 deg F., and the heat from the asphalt typically deforms and abrades the UHMW material causing the material, and the hopper flashing from which it is made, to fail. In fact, UHMW parts are permanently deformed due to the load applied at elevated temperatures.

As a result, known center hopper flashing is typically replaced an average of three times per year during the May-November paving season in the northern states. Each flashing replacement involves significant out-of-pocket cost and opportunity costs dues to paver downtime.

### SUMMARY

There is a need to an improved hopper flashing. There is a need for a hopper flashing made of material better suited to the temperatures and conditions of asphalt and paving. There is a need for a hopper flashing with improved longevity under typical conditions that is resistant to heat distortion as well as abrasion, cutting, and tearing.

While the typical materials (e.g., UHMW) appear to be a good material choices for hopper flashing based on tests conducted at room temperature, which is the temperature at which testing is typically conducted and data is typically reported, it turns out that this is not the case. For many applications material behavior at room temperature is sufficient but, for asphalt applications it turns out that room temperature testing data is not very useful as the temperatures for asphalt applications are 275 deg F. going up to 300+ deg F.

Generally speaking, a polymer material that is weaker at room temperature than UHMW would not be considered a logical choice or good substitute for UHMW at higher than room temperature, especially given that polymers tend to continue to lose strength as temperature increases. However, it turns out that UHMW, although stronger and/or stiffer than urethane at room temperature, loses so much strength relative to urethane as temperature rises that urethane, which remains more constant in strength and stiffness, is actually stronger at the range of asphalt application temperatures. It is surprising that the urethane, despite having a flexural modulus more than 10 times lower at room temperature, has a flexural modulus that is approximately 3 times higher at 270 deg F.

Additionally, UHMW is a thermoplastic material, which means that in addition to losing strength it does not return to its original shape when deformed under a load at elevated temperatures. The urethane, by keeping its properties relatively constant compared to the UHMW and being a thermoset returns to its original shape better than UHMW after being subjected to a typical load in a typical asphalt application. This advantage of urethane relative to UHMW that would not be obvious to or generally appreciated by a person choosing a material based on typically available material property information. As a result, known commercial flashings are produced in UHMW, but fail rather quickly as a replaceable wear item that end users must replace more often than desired.

Despite this, however, novel and improved hopper flashings are provided having the following features and/or one or more combinations of such features:

a hopper flashing that is made of polyurethane;

a hopper flashing that has longer work life relative to known flashings under similar conditions;

a hopper flashing that is resistant to abrasion, cutting and/or tearing;

a hopper flashing that is more optimized for, and resistant to heat distortion after, exposure to typical asphalt and paving temperatures; and

a hopper flashing the requires less frequent replacement and/or repair than known flashing.

Accordingly, an improved hopper flashing is provided, the flashing comprising: an upper portion, and a base portion configured to be coupled to a leading edge of a hopper of a paving machine; whereby the upper portion and base portion are made of a polyurethane compound.

Accordingly, an improved hopper flashing is provided, the flashing comprising: an upper portion, and a base portion configured to be coupled to a leading edge of a hopper of a paving machine; whereby the upper portion and base portion are made of a thermoset compound.

### BRIEF DESCRIPTION OF DRAWINGS

Various examples of embodiments of the systems, devices, and methods according to this invention will be described in detail, with reference to the following figures, wherein:

FIG. 1 illustrates a perspective view of hopper flashing system coupled to a hopper of a paver, according to various examples of embodiments;

FIG. 2 illustrates a perspective view of a center hopper flashing, according to various examples of embodiments;

FIG. 3 illustrates a side view of the center hopper flashing of FIG. 2;

FIG. 4 illustrates an cross-sectional view of the center hopper flashing of FIG. 2;

FIG. 5 illustrates a perspective view of hopper flashing system coupled to a hopper of a paver, according to various examples of embodiments;

FIG. 6 illustrates a perspective view of hopper flashing system including a center hopper flashing between two wing hopper flashings, according to various examples of embodiments;

FIG. 7 illustrates a perspective view of a center hopper flashing, according to various examples of embodiments;

FIG. 8 illustrates a front view of the center hopper flashing of FIG. 7;

FIG. 9 illustrates a perspective view of a wing hopper flashing, according to various examples of embodiments;

FIG. 10 illustrates a front view of the wing hopper flashing of FIG. 9;

FIG. 11 illustrates a perspective view of a hopper flashing system including a center hopper flashing between two wing hopper flashings, according to various examples of embodiments;

FIG. 12 illustrates a front view of a center hopper flashing, according to various examples of embodiments;

FIG. 13 illustrates a front view of a wing hopper flashing, according to various examples of embodiments;

FIG. 14 illustrates a perspective view of a hopper flashing system including a center hopper flashing between two wing hopper flashings, and two sidewall flashings, according to various examples of embodiments;

FIG. 15 illustrates a front view of a center hopper flashing, according to various examples of embodiments;

FIG. 16 illustrates a sectional view of the center hopper flashing of FIG. 15;

FIG. 17 illustrates a front view of a wing hopper flashing, according to various examples of embodiments;

FIG. 18 illustrates a sectional view of the wing hopper flashing of FIG. 17;

FIG. 19 illustrates a front view of a sidewall hopper flashing, according to various examples of embodiments;

FIG. 20 illustrates flexural modulus vs. temperature of UHMW and TDI ester urethane, according to various examples of embodiments;

FIG. 21 illustrates results of load vs. strain testing of UHMW, according to various examples of embodiments; and

FIG. 22 illustrates results of load vs. strain testing of TDI ester urethane, according to various examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, various examples of embodiments of hopper flashings are provided.

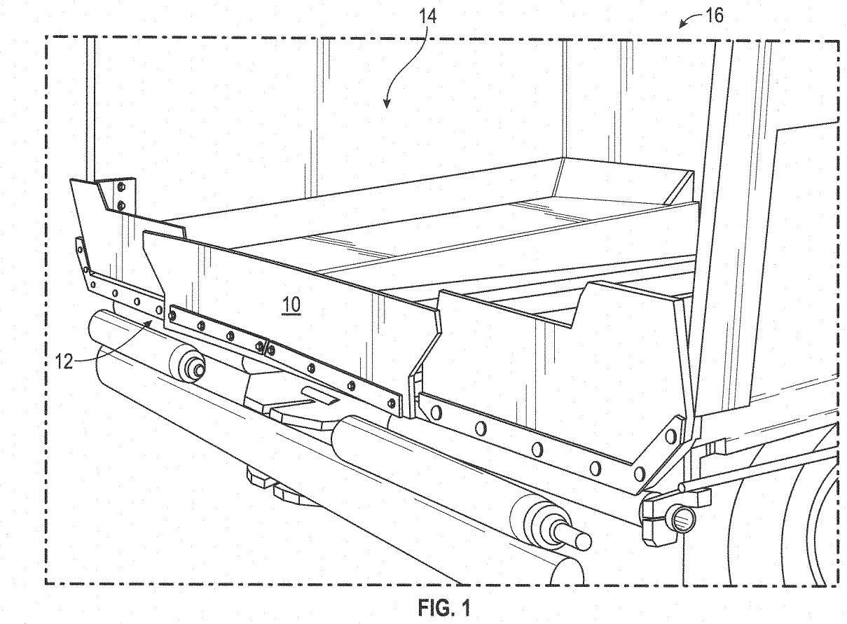

Referring to FIGS. 1-4, a hopper flashing 10 according to an example embodiment is illustrated. As illustrated in FIG. 1, hopper flashing 10 is provided along the lead or front edge 12 of a hopper 14 of a paver or paving machine 16. Hopper flashing 10 is generally provided to prevent excess spillage of asphalt in front of paver or paving machine 16.

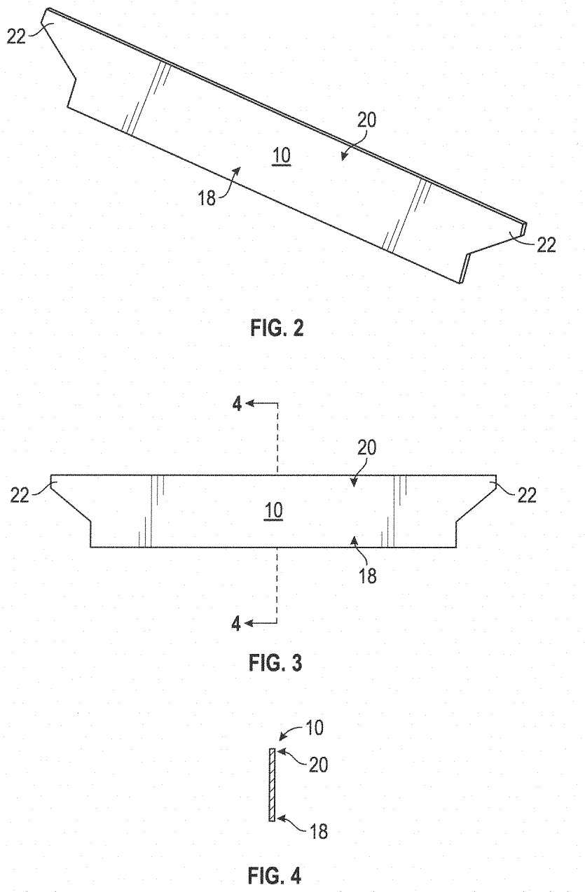

Referring more specifically to FIGS. 2-4, in various embodiments, hopper flashing 10 includes a base portion 18 and an upper portion 20. In various embodiments, upper portion 20 includes opposing side tabs or flaps 22 which extend beyond margins of base portion 18. In various embodiments, hopper flashing 10 includes a base portion 26 and an upper portion 28.

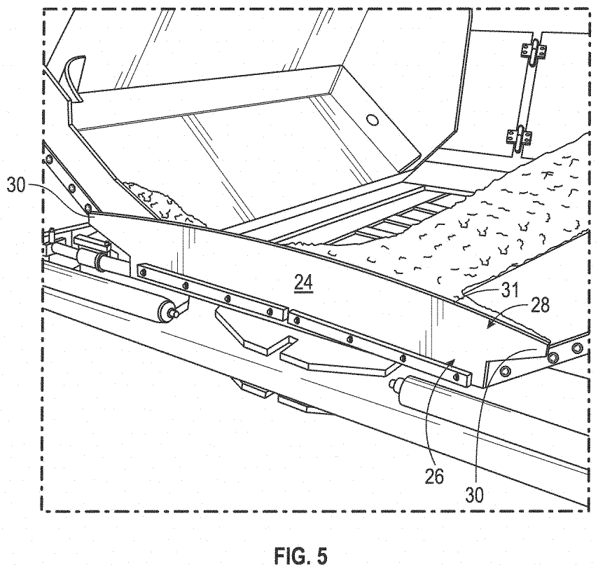

Referring now to FIG. 5, another embodiment of a hopper flashing 24 is shown. In various embodiments, upper portion 28 includes opposing side tabs or flaps 30 which extend beyond margins of base portion 26. In various examples of embodiments, upper portion includes an upper edge 31 that is curved.

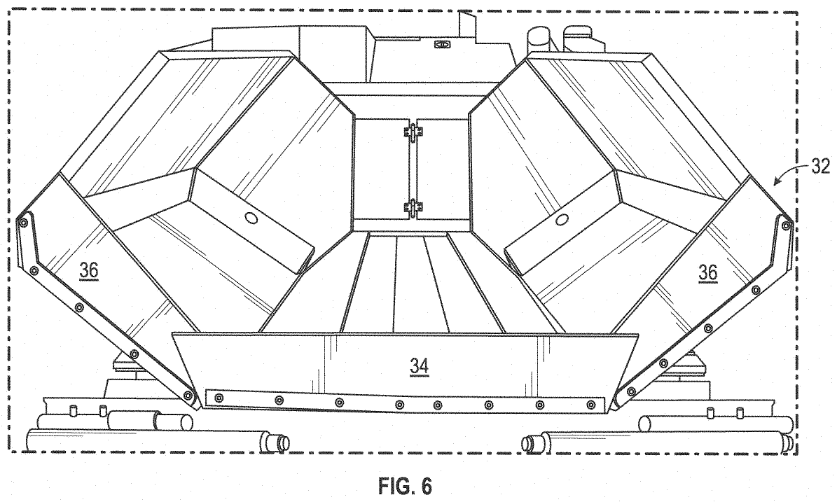

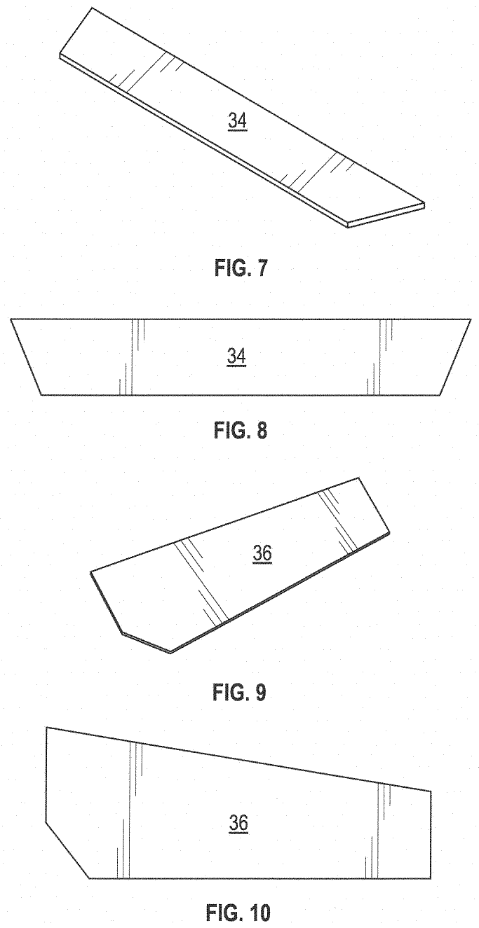

Referring now to FIGS. 6-10, an embodiment of a hopper flashing system 32 is illustrated. In various embodiments, hopper flashing system 32 includes a center hopper flashing 34 provided between two wing hopper flashings 36.

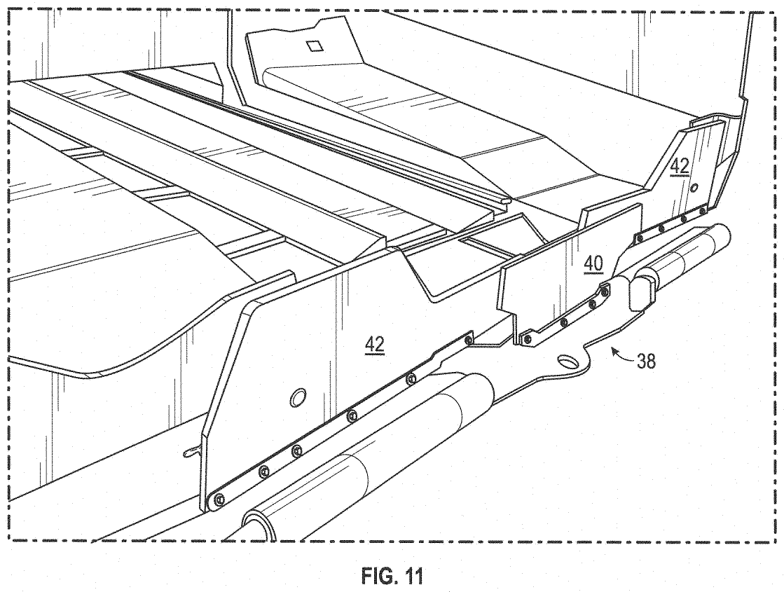

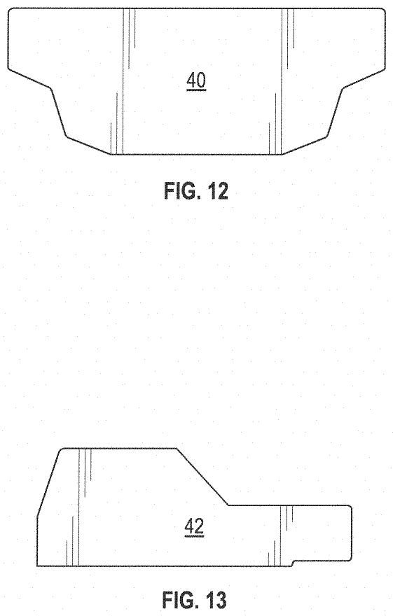

Referring now to FIGS. 11-13, another embodiment of a hopper flashing system 38 is illustrated. In various embodiments, hopper flashing system 38 includes a center hopper flashing 40 provided between two wing hopper flashings 42.

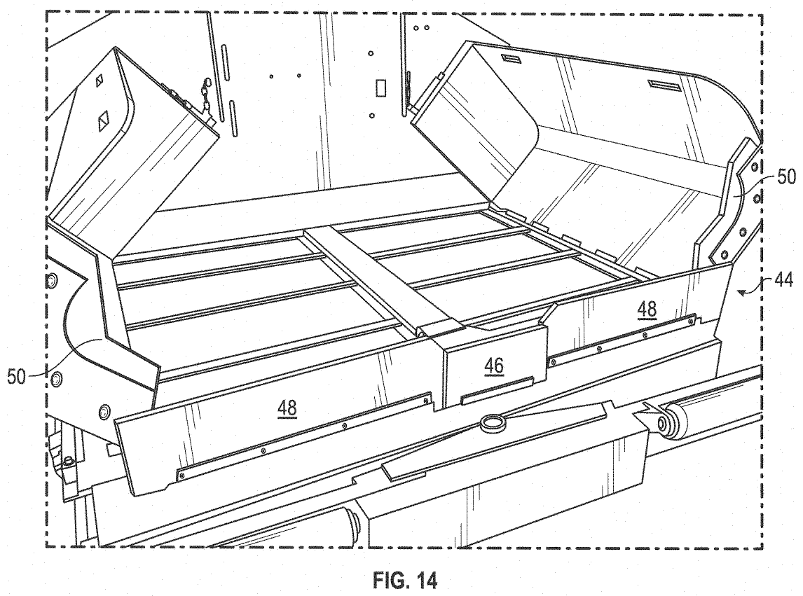

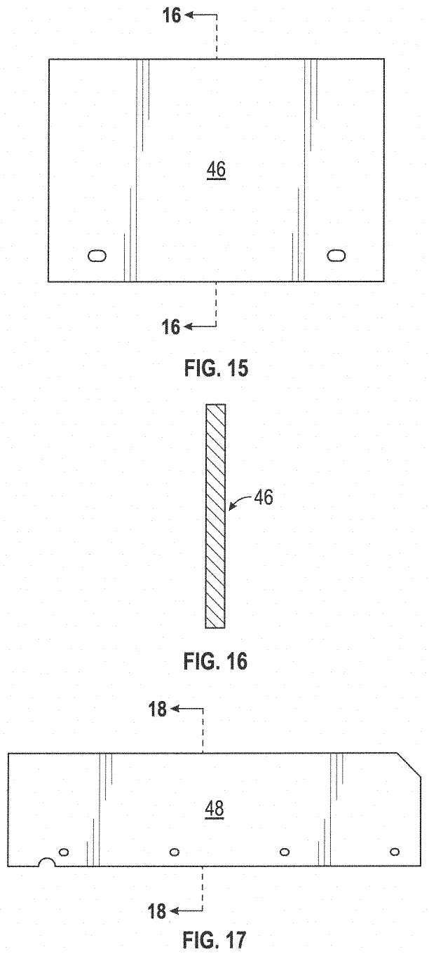

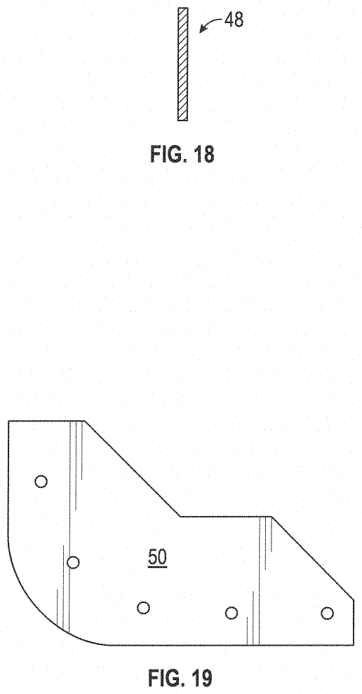

Referring now to FIGS. 14-19, another embodiment of a hopper flashing system 44 is illustrated. In various embodiments, hopper flashing system 44 includes a center hopper flashing 46 provided between two wing hopper flashings 48. In various embodiments, the hopper flashing system also includes one or more sidewall hopper flashings 50.

In various examples of embodiments, the hopper flashings are made of polyurethane. In various embodiments, the flashing is made from a polyurethane with an organized and well distributed polymer structure. Polyurethane compounds with more organized and rigid structures offer a better balance of properties with better cut and tear, higher abrasion resistance, and lower energy loss.

It should be appreciated that the hopper flashings disclosed herein may be made of any permutation of urethane. For example, the hopper flashing may be made of ULTRA-ES brand polyurethane from Superior Tire & Rubber Corp., of Warren, Pa. In various embodiments, the hopper flashing is made of MDI caprolactone or polycaprolactone polyurethane. In various embodiments, the hopper flashing is made of TDI ester polyurethane. It should be appreciated that the hopper flashing may be made of other urethanes and polyurethanes, including, without limitation, MDI esters or ethers, TDI esters or ethers, NDI esters or ethers, PPDI esters or ethers, and other urethane materials, or combinations of urethane materials.

In various embodiments, the hopper flashing is made of an elastomer with a torsion modulus of at least 2.3 E+08 dyn/cm² when at a temperature greater than 120 deg C., or between 120-150 deg C.

It should be appreciated that the material making up the hopper flashing may include one or more additives, fillers, reinforcements and/or combinations thereof. Additives such as heat stabilizers, fillers (e.g., for considerations of cost and/or strength enhancement), and/or reinforcing structures (such as, for example, fiberglass, mesh, cord or wire) may be added or used depending upon desired material properties, anticipated application, etc. For example, additives, fillers, and/or reinforcements may be utilized in highway paving applications with polymer modified asphalt, where temperatures are more extreme and for longer periods of time, relative to typical paving operations.

The following nonexclusive examples illustrate features of the present invention:

### Example 1

A center hopper flashing as illustrated in FIGS. 2-4 was manufactured using an MDI caprolactone, coupled to a leading or front edge of a hopper of a paver and tested. During the testing, trucks carrying asphalt backed in close to the leading or front edge of the hopper and hopper flashing and dumped asphalt into the hopper. During testing, truck approaches toward the hopper varied from slow and soft to relatively faster or quickly, at times slamming the paver, as is typical in the field.

In some cases, a base coat of asphalt of 19 mm average diameter media at approximately 235 deg F. was provided in the hopper. At other times, a top coat of asphalt of 19 mm average diameter media at approximately 300 deg F. was provided in the hopper.

When asphalt was in the hopper, the center hopper flashing temperature measured approximately 175 deg F. on the side facing into the hopper and about 110 deg F. on the opposing side.

A number of hopper loads and asphalt paving operations were conducted, during which time the hopper flashing was hit by workers with shovels, as is typical, to loosen material packed against the side of the flashing facing into the hopper. During testing, the workers indicated that the hopper flashing was improved over the known hopper flashing they typically saw.

After a number of paving operations, the hopper flashing made of the MDI caprolactone was examined and tested. Using an A scale durometer gauge, the hopper flashing hardness measured about 91 A at the tabs or flaps and about 89 A near the center. By comparison, a tested hopper flashing made of rubber was unmeasureable on the A scale durometer gauge at the tabs or flaps, and about 95 A near the center. The hopper flashing made of the MDI caprolactone exhibited less hardness after use, indicating that such a hopper flashing is more is resistant to abrasion, cutting and/or tearing, and likely to exhibit longer work life, relative to known rubber flashings under similar conditions. Consistent with expectations from the hardness testing, a visual inspection of the hopper flashing made of the MDI polycaprolactone exhibited some warping but no abrasion or tearing.

### Example 2

Samples of known UHMW, and samples of a TDI ester (80507 MOCA) and an MDI polycaprolactone (C930) were each torsionally deformed in a torsion test at a number of different temperatures, and the torsional modulus of elasticity (G¹) determined at each temperature. Data obtained from testing of modulus of elasticity at various temperatures of known UHMW flashing and hopper flashing disclosed herein is illustrated in Tables 1-3 below.

TABLE 1
UHMW 10 Hz 1% 2 Mar. 10

| Temp | G′ | G″ | | Torque | Freq | | ClockTime |
|---|---|---|---|---|---|---|---|
| ° C. | dyn/cm2 | dyn/cm2 | tan_delta | g-cm | Hz | Strain % | s |
| 30 | 2.56E+09 | 1.43E+08 | 0.05605 | 797.95 | 10 | 0.96324 | 14:56:42 |
| 40.01 | 2.14E+09 | 1.65E+08 | 0.07685 | 672.565 | 10 | 0.96697 | 15:02:13 |
| 50.01 | 1.78E+09 | 1.80E+08 | 0.10098 | 562.853 | 10 | 0.96993 | 15:07:43 |
| 60.02 | 1.47E+09 | 1.85E+08 | 0.12544 | 467.095 | 10 | 0.9726 | 15:13:14 |
| 70.02 | 1.20E+09 | 1.77E+08 | 0.14781 | 381.533 | 10 | 0.97581 | 15:18:46 |
| 80.01 | 9.51E+08 | 1.59E+08 | 0.16676 | 305.092 | 10 | 0.97744 | 15:24:17 |
| 90.01 | 7.35E+08 | 1.33E+08 | 0.18138 | 236.889 | 10 | 0.97982 | 15:29:49 |
| 100.02 | 5.45E+08 | 1.04E+08 | 0.19111 | 176.183 | 10 | 0.98162 | 15:35:21 |
| 110.01 | 3.78E+08 | 7.37E+07 | 0.19507 | 122.4 | 10 | 0.98259 | 15:41:29 |
| 120.03 | 2.25E+08 | 4.28E+07 | 0.19008 | 72.956 | 10 | 0.98393 | 15:47:04 |
| 130.01 | 7.05E+07 | 9.63E+06 | 0.13664 | 22.6849 | 10 | 0.98551 | 15:52:38 |
| 140.02 | 2.03E+07 | 1.03E+06 | 0.05099 | 6.48423 | 10 | 0.98592 | 15:58:13 |
| 150.02 | 2.03E+07 | 9.12E+05 | 0.04489 | 6.48956 | 10 | 0.98599 | 16:03:47 |

TABLE 2
8050T MOCA 95% 100 C. 19 Apr. 10

| Temp | G′ | G″ | | Torque | Freq | | ClockTime |
|---|---|---|---|---|---|---|---|
| ° C. | dyn/cm2 | dyn/cm2 | tan_delta | g-cm | Hz | Strain % | s |
| 29.99 | 5.79E+08 | 1.70E+08 | 0.29287 | 834.657 | 10 | 3.92368 | 16:33:58 |
| 40.01 | 4.08E+08 | 9.03E+07 | 0.22146 | 578.831 | 10 | 3.93039 | 16:39:29 |
| 50.01 | 3.27E+08 | 4.85E+07 | 0.14816 | 458.793 | 10 | 3.93433 | 16:45:00 |
| 60.01 | 2.92E+08 | 2.61E+07 | 0.0895 | 406.164 | 10 | 3.93478 | 16:50:32 |
| 70.02 | 2.75E+08 | 1.44E+07 | 0.05241 | 381.485 | 10 | 3.93617 | 16:56:03 |
| 80.02 | 2.67E+08 | 8.57E+06 | 0.03248 | 370.7 | 10 | 3.93705 | 17:01:34 |
| 90.02 | 2.64E+08 | 7.20E+06 | 0.02724 | 366.907 | 10 | 3.93668 | 17:07:06 |
| 100.02 | 2.65E+08 | 7.07E+06 | 0.02672 | 367.534 | 10 | 3.93713 | 17:12:40 |
| 110.02 | 2.65E+08 | 6.27E+06 | 0.02365 | 367.86 | 10 | 3.93649 | 17:18:14 |
| 120.02 | 2.63E+08 | 5.86E+06 | 0.02228 | 364.825 | 10 | 3.9367 | 17:23:48 |
| 130.01 | 2.56E+08 | 5.77E+06 | 0.02252 | 355.838 | 10 | 3.93748 | 17:29:25 |
| 140.03 | 2.43E+08 | 5.92E+06 | 0.02435 | 337.823 | 10 | 3.9372 | 17:35:00 |

TABLE 3
C930_CONTROL_10HZ_30-140C_4%_07OCT09

| Temp | G′ | G″ | | Torque | Freq | | ClockTime |
|---|---|---|---|---|---|---|---|
| ° C. | dyn/cm2 | dyn/cm2 | tan_delta | g-cm | Hz | Strain % | s |
| 29.99 | 2.26E+08 | 8.96E+06 | 0.03962 | 1036.29 | 10 | 3.84612 | 16:49:35 |
| 40.01 | 2.28E+08 | 7.93E+06 | 0.03484 | 1041.93 | 10 | 3.84527 | 16:55:06 |
| 50.02 | 2.29E+08 | 7.18E+06 | 0.03142 | 1049.38 | 10 | 3.84717 | 17:00:36 |
| 60.01 | 2.33E+08 | 6.46E+06 | 0.02773 | 1066.67 | 10 | 3.84771 | 17:06:07 |
| 70.02 | 2.33E+08 | 6.29E+06 | 0.02696 | 1068.84 | 10 | 3.84561 | 17:11:37 |
| 80.02 | 2.36E+08 | 6.09E+06 | 0.02581 | 1079.56 | 10 | 3.8444 | 17:17:09 |
| 90.02 | 2.38E+08 | 5.95E+06 | 0.02499 | 1089.3 | 10 | 3.84403 | 17:22:41 |
| 100.03 | 2.40E+08 | 5.90E+06 | 0.02458 | 1098.34 | 10 | 3.84525 | 17:28:15 |
| 110.03 | 2.41E+08 | 5.84E+06 | 0.02421 | 1103.71 | 10 | 3.84381 | 17:33:48 |
| 120.03 | 2.42E+08 | 5.86E+06 | 0.02422 | 1107.0 | 10 | 3.84411 | 17:39:22 |
| 130.02 | 2.42E+08 | 5.95E+06 | 0.02463 | 1105.59 | 10 | 3.84358 | 17:44:57 |
| 140.03 | 2.40E+08 | 6.14E+06 | 0.02556 | 1099.67 | 10 | 3.84415 | 17:50:31 |

As can be seen from Tables 1-3, as expected the known UHMW had a higher modulus than either TDI ester or MDI polycaprolactone at or about room temperature. But, TDI ester and MDI polycaprolactone unexpectedly exhibited a higher modulus as the temperature at testing reaches 120 deg C., which temperature is closer to temperature of asphalt paving conditions. The results of this testing indicate that a flashing made of polyurethane such as TDI ester or MDI polycaprolactone will be more optimal for paving conditions, and may have longer life under such conditions, relative to known flashing made of UHMW.

### Example 3

TDI ester polyurethane was compared to known hopper flashing material, UHMW. In order to compare the materials at elevated temperatures, the studies were completed using an Instron brand testing apparatus fitted with a temperature controlled chamber. After completing both flexural and tensile testing at temperatures that mimicked asphalt paving conditions, TDI ester polyurethane proved to be significantly better in flexural modulus, tensile modulus, and yield stress measurements.

While material properties were known for both UHMW and TDI) ester polyurethane at room temperature, little was known about these properties at the 270° F.-325° F. operating temperatures experienced during asphalt paving operations. The current application of the hopper flashings is to help contain the hot asphalt inside of the paver. Because these hopper flashings commonly experience impact while in use, it was decided that both tensile and flexural testing would best study properties of importance to the application. The ASTM standard tests that were used to compare the two materials are described below.

Flexural testing (ASTM D790) measures the amount of force that is required to bend the test specimen under three-point loading conditions. The crosshead of a Tinius-Olsen universal testing machine was used to apply a load to the center of the test specimen spanning between two fixed points. The measurements gathered from the flex test include the flexural modulus, maximum load, and maximum stress. These three properties help describe the rigidity and strength of the material when loaded.

Flexural modulus, which is also known as the “bend modulus,” describes the overall stiffness of the material. Because the materials that were tested are anisotropic, the flexural modulus and tensile modulus will not be equal in value. Maximum load describes the amount of load that the test specimen can withstand at 5.0% strain. Maximum stress describes the amount of stress that the test specimen can withstand at 5.0% strain.

Tensile testing (ASTM D638) measures the flexibility of the test specimen along the axis of strain. The crosshead of the same universal testing machine pulled the specimen apart at a constant rate until necking or failure occurred. The measurements extracted from tensile testing include tensile modulus, yield stress, and elongation at yield.

Tensile modulus describes the tendency of the material to deform when exposed to forces in tension. It is defined as the ratio of stress and strain in the material's elastic region.

Yield stress describes the amount of stress that the test material can withstand before experiencing permanent (plastic) deformation. Yield elongation describes the percentage that the test specimen elongated at the point of yield.

The flexural testing and tensile testing parameters are shown in Tables 4 and 5 below.

TABLE 4
Flexural Testing Parameters
Flexural Test Parameters

| Specimen | 5.00° × 0.50° × .125° thick (ASTM D790 Standard) |
|---|---|
| Dimensions | |
| Temperature | 270° F.-325° F. |
| Condition Time | 2 min. |
| Crosshead Speed | 0.50 in/min |
| Span of Fixture | 2.00 in |
| Max Strain Limit | 5.0% |

TABLE 5
Tensile Testing Parameters
Tensile Test Parameters

| | |
|---|---|
| Specimen Dimensions | ASTM D-412C Dumbbell (∞Type 4) |
| Temperature | 270° F. |
| Condition Time | 2 min. |
| Crosshead Speed | 2.00 in/min |

Comparing the results of the flexural testing at asphalt temperatures showed a significant difference between TDI ester polyurethane and UHMW. Although the UHMW samples were significantly stiffer than the TDI ester polyurethane samples at room temperature, the UHMW experienced a dramatic change of properties in the 180 deg F.-220 deg F. temperature region. When the testing data was completed at 270 deg F., what most consider the lower end of asphalt temperatures, the flexural modulus of UHMW had already dropped below TDI ester polyurethane by almost three times. As the testing temperature was increased to 325 deg F., the UHMW material produced unmeasurable results because the material had become so soft and flexible. Only a small decrease in flexural modulus was measured at these extreme asphalt temperatures for the TDI ester polyurethane. While it is not intuitive at room temperature that a TDI ester polyurethane compound would out-perform UHMW at typical asphalt temperatures, the testing showed that there is a dramatic difference in material behavior once asphalt temperatures are reached.

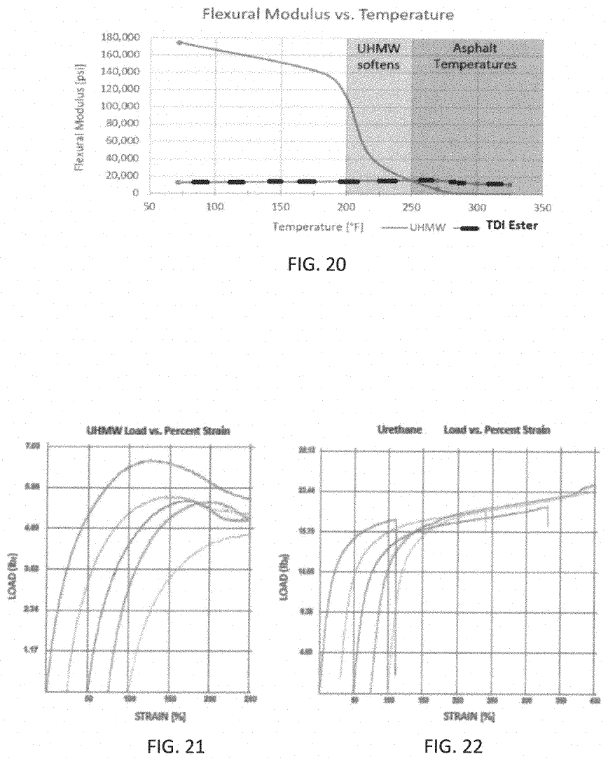

The graph in FIG. 20 illustrates the transition in material stiffness as temperature was increased. It should be appreciated that, while the data points shown represent test data, the UHMW trend line between 50 deg F. and 270 deg F. is a conceptual approximation. However, in testing at 270 deg F., TDI ester polyurethane exhibited a higher flexural modulus that UHMW.

Additional flexural testing data including maximum load and maximum stress of TDI ester polyurethane (labeled as “Urethane”) can be seen in Table 6 below.

TABLE 6

| | | Flexural | | Max | | | Flexural | | Max |
|---|---|---|---|---|---|---|---|---|---|
| | | Modulus | Max Load | Stress | | | Modulus | Max Load | Stress |
| | Temp. | [psi] | [lbf] | [psi] | | Temp. | [psi] | [lbf] | [psi] |
| Urethane | 72° F. | 12463 | 1.65 | 590 | UHMWPE | 72° F. | 174483 | 11.88 | 4188 |
| | 270° F. | 15106 | 1.31 | 569 | | 270° F. | 4802 | 0.17 | 66 |

| | | | | | |
|---|---|---|---|---|---|
| 300° F. | 11654 | 1.22 | 437 | 300° F. | No measurable results |
| 325° F. | 10870 | 1.15 | 397 | 325° F. | No measurable results |

The UHMW samples remained deformed after flex testing while the TDI ester polyurethane remained more true to their original shape. This permanent deformation of the UHMW after exposure to heat and impact mimic results seen in the field.

Comparing the tensile results at 270 deg F. showed similar results in regards to strength of the TDI ester polyurethane compound. In the testing, both the tensile modulus and yield stress of TDI ester polyurethane are almost five times greater than that of the UHMW. Table 7 presents the tensile modulus, yield stress, the yield elongation of both materials (with TDI ester polyurethane labeled as “Urethane”) tested at 270 deg F.

TABLE 7
Tensile Test Results at 270 deg F.

| | | Tensile | Yield | Yield | | | Tensile | Yield | Yield |
|---|---|---|---|---|---|---|---|---|---|
| | | Modulus | Stress | Elongation | | | Modulus | Stress | Elongation |
| | Sample | [psi] | [psi] | [%] | | Sample | [psi] | [psi] | [%] |
| Urethane 508 | 2 | 2550 | 616 | 109 | UHMWPE | 2 | 610 | 195.1 | 135.2 |
| | 3 | 994 | 679 | 215 | | 3 | 638 | 171.9 | 116 |
| | 4 | 2920 | 673 | 281 | | 4 | 455 | 159.7 | 110.7 |
| | 5 | 2690 | 690 | 344 | | 5 | 497 | 162.1 | 124.7 |
| | 6 | 3030 | 782 | 417 | | 6 | 368 | 134.3 | 191.6 |
| | AVG | 2437 | 688 | 273 | | AVG | 514 | 164.6 | 135.6 |

FIGS. 21-22 illustrates the load vs. strain testing data from which the tensile modulus was derived. It should be appreciated that the graphed lines in FIGS. 21-22 are offset from the origin so that they do not overlap and make the graphs difficult to read.

Evaluation of UHMW and TDI ester polyurethane in testing showed that the TDI ester polyurethane compound had significantly better properties to serve the hopper flashing application. The three critical properties appear to be flexural modulus, tensile modulus, and yield stress. In these three areas, the TDI ester polyurethane compound had a three times greater flexural modulus, a five times greater tensile modulus, as well as a six times greater yield stress than that of the UHMW. These measurements indicate that, as between UHMW and TDI ester polyurethane, the TDI ester polyurethane compound is the material best suited material for a typical hopper flashing application.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A hopper flashing comprising:
an upper portion, and a base portion configured to be coupled to a leading edge of a hopper of a paving machine;
whereby the upper portion and base portion are made of a polyurethane compound.

2. The hopper flashing of claim 1, whereby the polyurethane compound has an organized and distributed polymer structure.

3. The hopper flashing of claim 2, whereby the polyurethane compound has an optimally organized and distributed polymer structure.

4. The hopper flashing of claim 1, whereby the polyurethane compound has a torsion modulus of at least 2.3 E+08 dyn/cm² when at a temperature greater than 120 deg C.

5. The hopper flashing of claim 1, whereby the polyurethane is an MDI caprolactone polyurethane.

6. The hopper flashing of claim 1, whereby the polyurethane is an MDI polycaprolactone polyurethane.

7. The hopper flashing of claim 1, whereby the polyurethane is a TDI ester.

8. The hopper flashing of claim 1, whereby the hopper flashing is provided along a lead edge of a hopper of a paving machine.

9. The hopper flashing of claim 8, whereby the hopper flashing is provided between two wing hopper flashings.

10. The hopper flashing of claim 1, whereby the upper portion includes tabs that extend longitudinally beyond margins of the lower portion.

11. A hopper flashing comprising:
an upper portion, and a base portion configured to be coupled to a leading edge of a hopper of a paving machine;
whereby the upper portion and base portion are made of thermoset compound.

12. The hopper flashing of claim 11, whereby the thermoset compound has an organized and distributed polymer structure.

13. The hopper flashing of claim 12, whereby the thermoset compound has an optimally organized and distributed polymer structure.

14. The hopper flashing of claim 12, whereby the thermoset compound has a torsion modulus of at least 2.3 E+08 dyn/cm² when at a temperature greater than 120 deg C.

15. The hopper flashing of claim 11, whereby the thermoset compound is an MDI caprolactone polyurethane.

16. The hopper flashing of claim 11, whereby the thermoset compound is an MDI polycaprolactone polyurethane.

17. The hopper flashing of claim 11, whereby the thermoset compound is a TDI ester.

18. The hopper flashing of claim 11, whereby the hopper flashing is provided along a lead edge of a hopper of a paving machine.

19. The hopper flashing of claim 18, whereby the hopper flashing is provided between two wing hopper flashings.

20. The hopper flashing of claim 11, whereby the upper portion includes tabs that extend longitudinally beyond margins of the lower portion.
